(19) United States
(12) Patent Application Publication
(10) Pub. No.: US 2010/0239405 A1
(43) Pub. Date: Sep. 23, 2010

(54) Boom extension apparatus

(76) Inventor: Vincent E. Tesinsky, Weston, NE (US)

Correspondence Address: THOMTE LAW OFFICE, L.L.C., 2120 S. 72ND STREET, SUITE 1111, OMAHA, NE, 68124, US

(21) Appl. No.: 12/383,163

(22) Filed: Mar. 20, 2009

(51) Int. Cl. B66F 9/075

(52) U.S. Cl. 414/686; 414/718; 414/697

(57) ABSTRACT

A boom extension apparatus is provided for a prime mover such as a skid-steer loader or vehicle wherein the rearward end of the boom extension apparatus is quickly and easily attachable to the forward ends of the boom arms of the skid-steer loader. The forward end of the boom extension apparatus is quickly and easily attachable to the rearward end of an implement such as a bucket, bale spear, etc.

### BACKGROUND OF THE INVENTION

1. Field of the Invention

This invention relates to a boom extension apparatus for a prime mover such as a skid-steer loader or vehicle.

2. Description of the Related Art

Skid-steer vehicles which are commonly referred to as skid-steer loaders such as the popular Bobcat® skid-steer loader include a wheeled frame having a pair of drive wheels at one side thereof and a pair of drive wheels at the other side thereof. A pair of elongated boom arms are pivotally connected to the wheeled frame at their rearward ends and extend forwardly therefrom. The boom arms are usually raised and lowered by means of a pair of hydraulic cylinders extending between the frame and the boom arms. Inasmuch as the skid-steer loaders normally are smaller than conventional farm tractors, the boom arms of the skid-steer loaders have a limited height and reach. In most cases, the forward ends of the boom arms have a conventional implement quick-attach apparatus, assembly or structure thereon to enable an implement to be quickly and easily attached thereto and detached therefrom. The various implements adapted for use with the skid-steer loader have quick-attach structures provided on the rearward ends thereof for mating attachment to the quick-attach assemblies on the forward ends of the boom arms. In some cases, the quick-attach structure on the forward ends of the boom arms is referred to as a male quick-attach while the quick-attach structure on the rearward end of the implement is referred to as a female quick-attach component.

In the prior art skid-steer loaders, the boom arms are limited in their height and reach. When a bucket or the like is attached to the boom arms, the rear of the bucket is positioned closely to the front of the skid-steer loader which makes it difficult for the operator of the vehicle to observe the rear of the bucket when the bucket is positioned near the ground especially when the bucket is being used to drag material such as dirt or snow rearwardly.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A boom extension apparatus is provided for effectively extending the boom arms on a prime mover such as a skid-steer loader or vehicle so that the implement on the extension apparatus may be lifted to a higher location or moved father away from the vehicle. The extension apparatus of this invention includes an extender frame having rearward and forward ends with the rearward end of the extender frame having a female quick-attach mounting structure mounted thereon adapted to be quickly attached to the conventional male implement quick-attach structure pivotally mounted on the forward ends of the boom arms.

The forward end of the extender frame has a male implement quick-attach mounting structure thereon which is pivotally secured thereto and which is adapted to have an implement such as a bucket, bale spear, grapple, etc. quickly and easily secured thereto by way of the female quick-attach structure at the rear end of the implement.

It is therefore a principal object of the invention to provide a boom extension apparatus for a skid-steer loader or the like.

A further object of the invention is to provide an extension apparatus for the boom arm of a skid-steer loader or the like which enables the implement on the forward end of the boom extension apparatus to be positioned at a greater height than normally possible.

Still another object of the invention is to provide an extension apparatus for the boom arms of a skid-steer loader or the like which enables the implement positioned on the forward end of the boom extension apparatus to be positioned farther away from the vehicle.

Yet another object of the invention is to provide a boom extension apparatus which enables the implement secured thereto to have an extra pivot over that of the prior art.

Yet another object of the invention is to provide a boom extension apparatus which is quickly and easily attachable to the conventional quick-attach structure on the boom arms of a skid-steer loader or the like.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a side view illustrating a skid-steer loader having the boom extension apparatus of this invention mounted on the forward ends of the boom arms of a loader;

FIG. 2 is a front perspective view of the boom extension apparatus of this invention;

FIG. 3 is an exploded perspective view of the boom extension apparatus of this invention;

FIG. 4 is a side view of the boom extension apparatus of this invention mounted on the forward ends of the boom arms of a loader and having an implement mounted on the forward end of the boom extension apparatus, with portions of the apparatus cut-away to more fully illustrate the invention.

FIG. 5 is a partial rear perspective view of the right rear portion of the apparatus of this invention;

FIG. 6 is a partial front perspective view of the right front portion of the apparatus of this invention; and

FIG. 7 is a partial side elevational view of the quick-attach structure at the forward end of the boom extension apparatus of this invention.

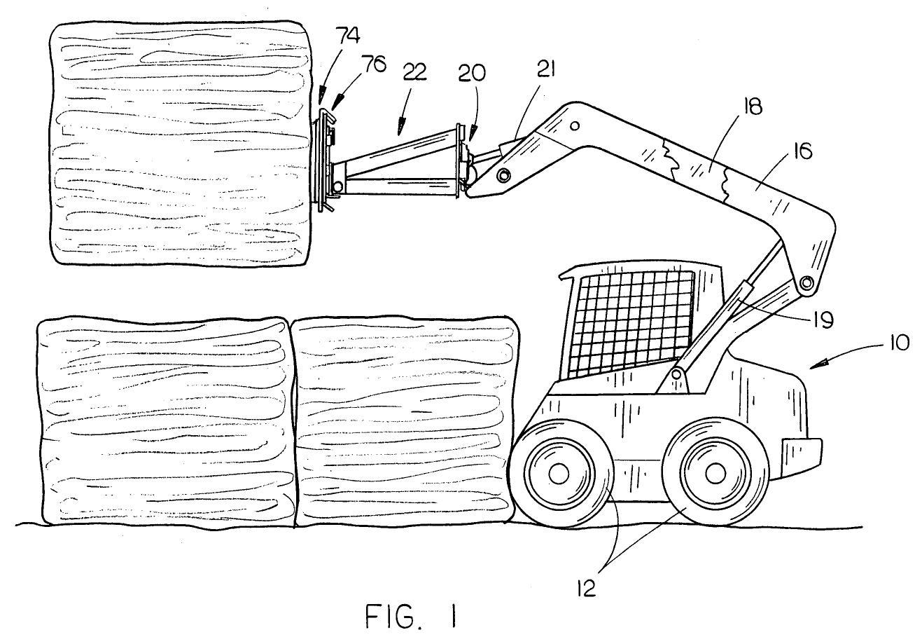

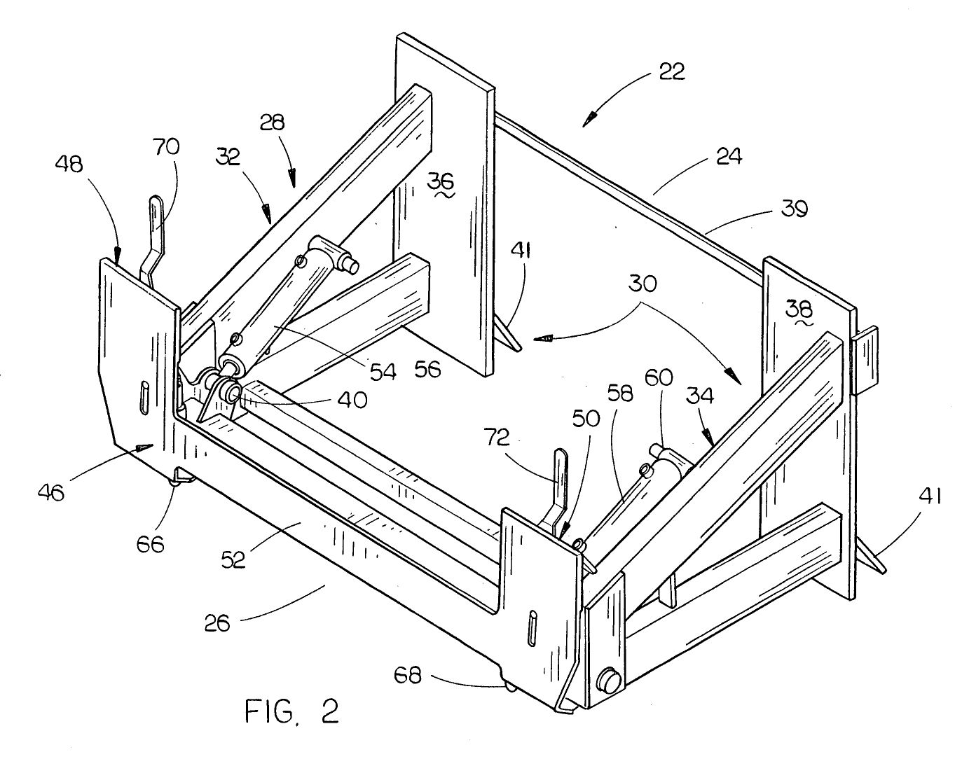

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to a prime mover such as a conventional skid-steer loader or vehicle having a pair of driven wheels 12 at one side thereof and a pair of driven wheels at the other side thereof which are identical to driven wheels 12. Loader 10 includes a pair of boom arms 16 and 18 which are pivoted at their rearward ends to the loader and which extend forwardly therefrom. The boom arms 16 and 18 are raised and lowered in conventional fashion such as by a pair of hydraulic cylinders 19 in conventional fashion. The numeral 20 refers to a conventional implement mounting structure of the male quick-attach type which is secured to the forward end of the boom arms 16 and 18 and which is pivotally movable with respect thereto by means of one or more hydraulic cylinders 21 extending between the boom arms and the structure 20.

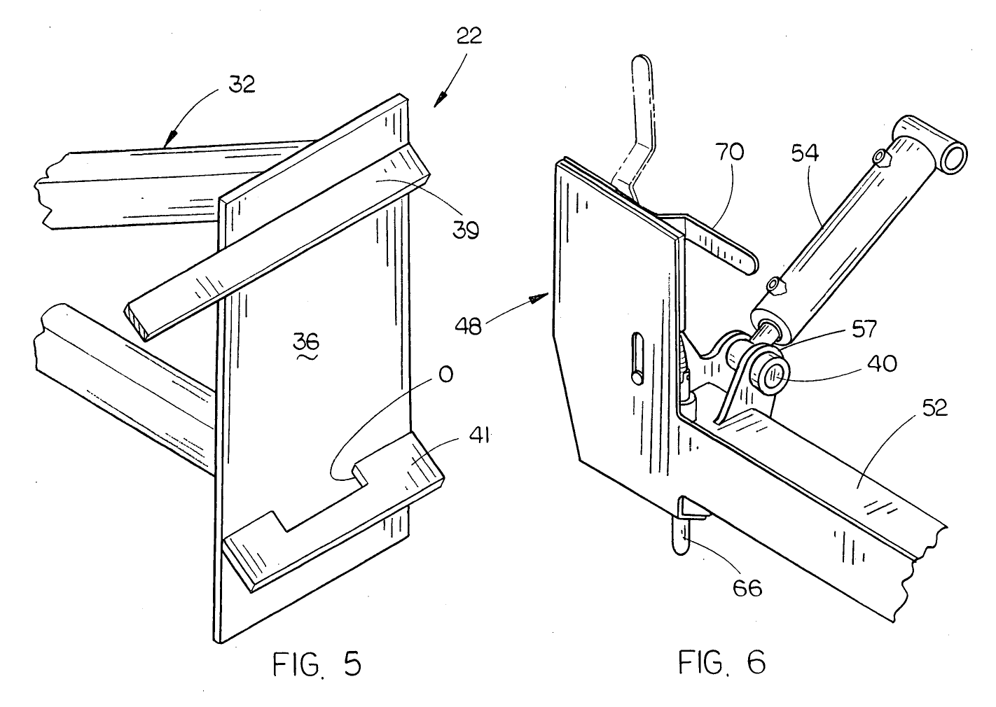

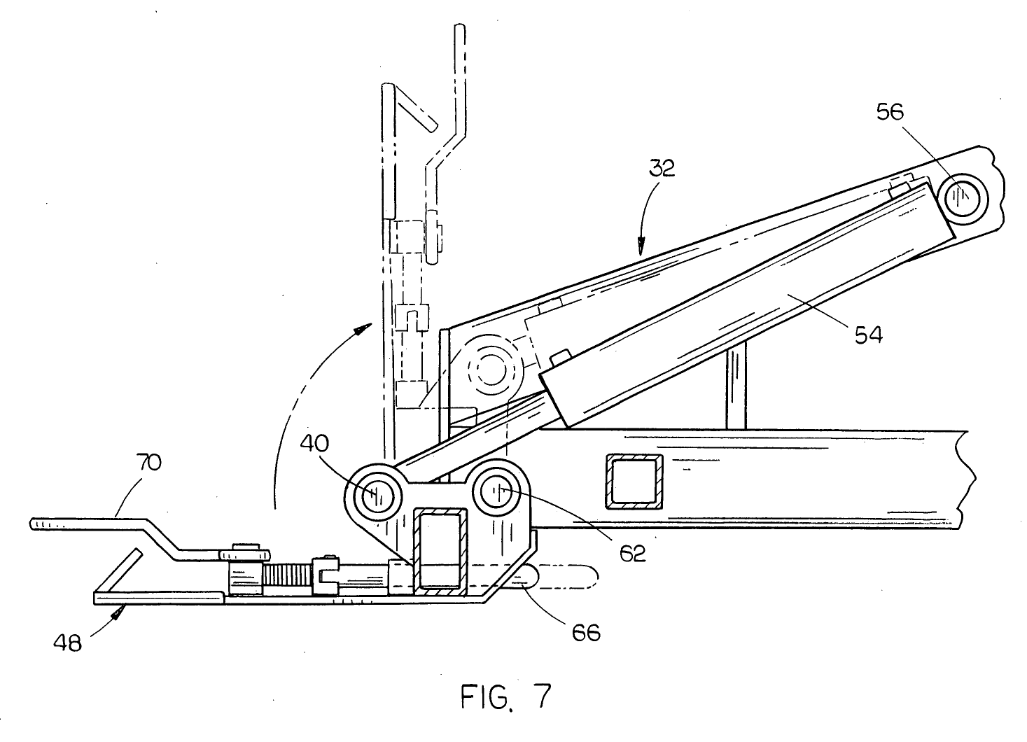

The numeral 22 refers to the boom extension apparatus of this invention having a rearward end 24 and a forward end 26. Apparatus 22 includes an elongated frame means generally referred to by reference numeral 28. A conventional female quick-attach structure 30, which is normally found at the rear of an implement, is provided at the rear of the apparatus 22 so that the apparatus 22 may be attached to the quick-attach structure 20 on the boom arms 16 and 18. Frame means 28 includes side frames 32 and 34 having the plates 36 and 38 of the conventional quick-attach structure 30 secured thereto respectively. Angle brace or frame 39 is secured to and extends between plates 36 and 38. Side frames 32 and 34 extend forwardly from the forward end of plates 36 and 38 respectively with the lower forward ends thereof having openings 33 and 35 formed therein respectively. Brace or frame 39 is angled as seen in FIG. 5 and serves as an upper attachment point for the upper forward end of the quick-attach structure 20 at the forward ends of boom arms 16 and 18.

Plate 36 has an angled lower attachment point 41 provided at its rearward side which has an opening 0 formed therein. Plate 38 has identical structure at its rearward side. The openings 0 in the points 41 are adapted to receive locking pins 66 and 68 therein as will be described hereinafter.

The numeral 46 refers to a conventional quick-attach structure or assembly which would normally be pivotally secured to the forward ends of boom arms 16 and 18. Assembly or structure 46 includes conventional male quick-attach structures 48 and 50 which have a frame 52 secured thereto and extending therefrom. The lower rearward ends of structures 48 and 50 are provided with bushings 49 and 51 mounted thereon respectively.

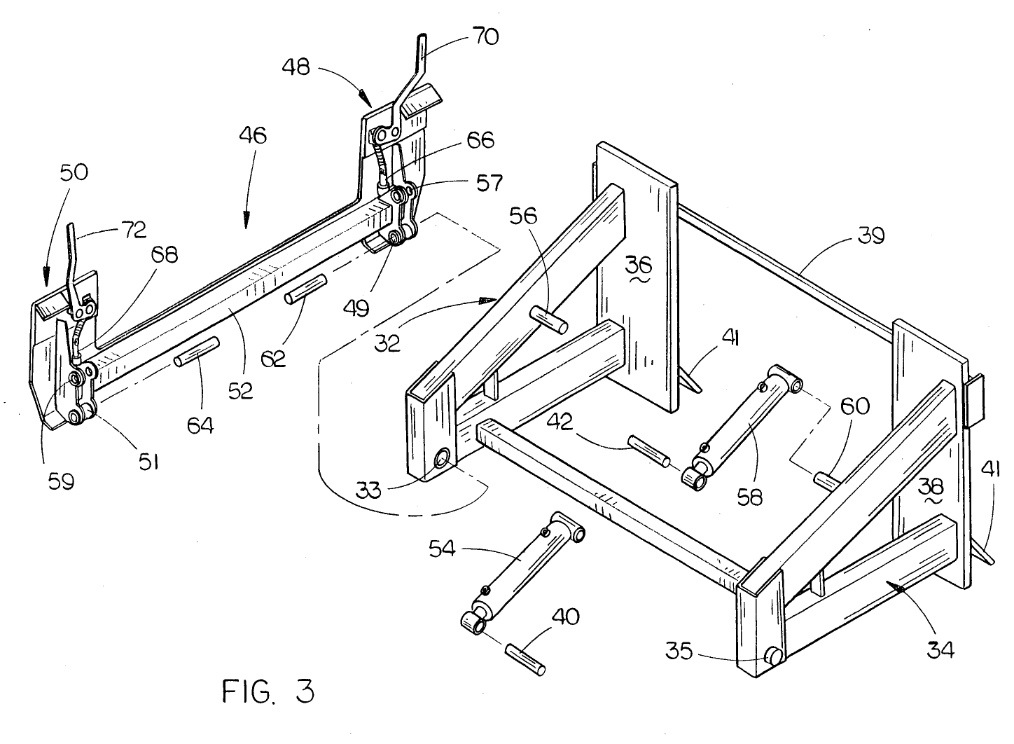

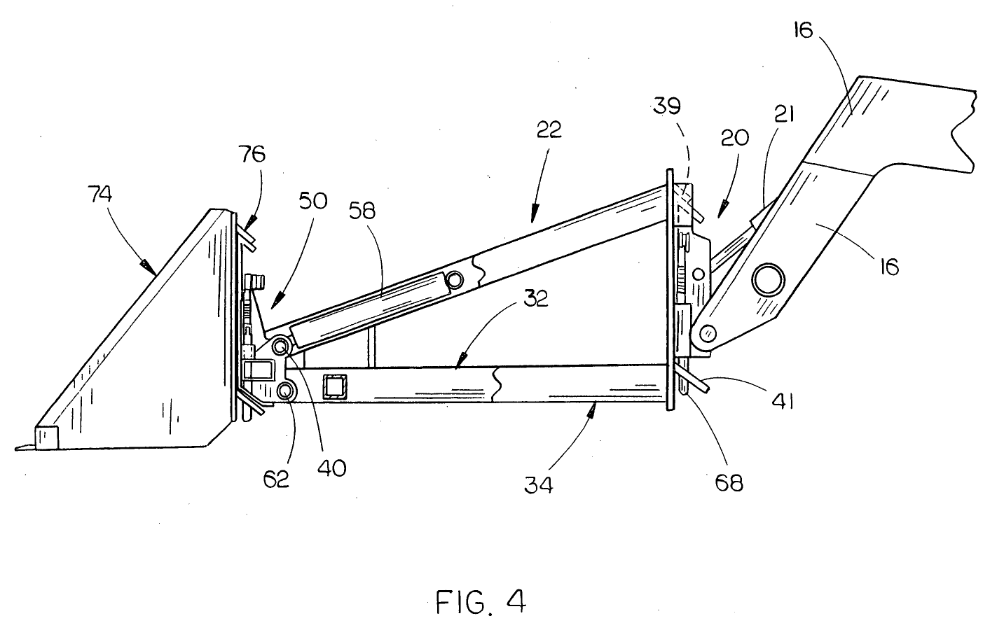

A hydraulic cylinder 54 has its rearward end pivoted to side frame 32 at 56 and has its rod end pivotally secured to structure 48 at 57 by pin 40. Similarly, a hydraulic cylinder 58 is pivotally connected at its rearward end to side frame 34 at 60 and has its rod end pivotally secured to structure 50 at 59 by pin 42. The quick-attach structure 48 is pivoted to the bushings 49 and 51 at the lower forward ends of side frames 32 and 34 by pins 62 and 64 respectively which also extend through openings 33 and 35 respectively. As seen in FIG. 3, structures 48 and 50 include conventional locking pins 66 and 68 which are operated by locking levers 70 and 72 respectively. The extension and retraction of the cylinders 54 and 58 causes the quick-attach structure 48 to be pivotally moved about the pivot pins 62 and 64.

Again, it must be noted that the quick-attach structures at the forward and rearward ends of the boom extension apparatus 22 are identical to that of conventional quick-attach structures. The quick-attach structure 46 is adapted to be coupled or attached to the rearward end of an implement 74 having a female quick-attach structure at the rearward end thereof.

Thus, it can be seen that the boom extension apparatus of this invention effectively extends the reach of the boom arms therefore extending the reach of the attachments for implements secured to the forward end of the boom extension apparatus. The boom extension apparatus of this invention allows attachments or implements to reach higher and still be able to dump the load carried thereby. The boom extension apparatus of this invention also permits the operator to observe what is happening behind the attachment or implement and provides room for material to build up when the attachment or implement is being used to drag material or the like rearwardly. It can also be seen that the boom attachment apparatus of this invention spaces the skid-steer vehicle away from branches when cutting and grappling trees. The boom extension apparatus of this invention also permits larger and higher piles of dirt, trees, etc. to be created. Additionally, the boom apparatus of this invention permits the loading and stacking of hay bales a much easier task.

It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific, aspects and steps are described as forms of implementing the claimed invention. Since many embodiments of the invention can be practiced without departing from the spirit and scope of the invention, the invention resides in the claims hereinafter appended.

1. In combination with a prime mover including first and second boom arms having rearward and forward ends with the rearward ends of the first and second boom arms being pivotally secured to the prime mover with the forward end of each of the first and second boom arms having a quick-attach implement mounting apparatus pivotally secured thereto about a horizontal axis transverse to the respective boom arm, comprising:
a boom arm extension apparatus having rearward and forward ends;
said boom arm extension apparatus having first and second horizontally spaced-apart quick-attach assemblies mounted on the rearward end thereof which may be selectively attached to the quick-attach implement mounting apparatus on the forward end of the first and second boom arms respectively for movement therewith;
and a quick-attach implement mounting apparatus at the forward end of said boom arm extension apparatus adapted to have an implement attached thereto;
said quick-attach implement mounting apparatus at the forward end of the boom arm extension apparatus being pivotally mounted thereto about a horizontal axis transverse to the boom arms.

2. The combination of claim 1 wherein the implement is a materials handling implement.

3. The combination of claim 1 wherein said boom arm extension apparatus includes an elongated frame means extending between said forward and rearward ends thereof.

4. The combination of claim 1 wherein said quick-attach implement mounting apparatus at the rearward end of said boom arm extension apparatus comprises first and second horizontally spaced-apart quick-attach members.

5. The combination of claim 4 wherein said quick-attach implement mounting apparatus at the forward end of said boom arm extension apparatus comprises first and second horizontally spaced-apart quick-attach members.

6. In combination with a prime mover including first and second boom arms having rearward and forward ends with the rearward ends of the first and second boom arms being pivotally secured to the prime mover and with the forward end of each of the first and second boom arms having a quick-attach implement mounting apparatus pivotally secured thereto about a horizontal axis transverse to the respective boom arm,
a boom arm extension apparatus having rearward and forward ends;
said boom arm extension apparatus having first and second horizontally spaced-apart quick-attach assemblies mounted on the rearward end thereof which may be selectively attached to the quick-attach implement mounting apparatus on the forward end of the first and second boom arms respectively for movement therewith;
and a quick-attach implement mounting apparatus at the forward end of said boom arm extension apparatus adapted to have an implement attached thereto;
said quick-attach implement mounting apparatus at the forward end of the boom arm extension apparatus being pivotally mounted thereto about a horizontal axis transverse to the boom arms.

7. The combination of claim 6 wherein the implement is a materials handling implement.

8. The combination of claim 6 wherein said boom arm extension apparatus includes an elongated frame means extending between said forward and rearward ends thereof.

9. The combination of claim 6 wherein said quick-attach implement mounting apparatus at the rearward end of said boom arm extension apparatus comprises first and second horizontally spaced-apart quick-attach members.

10. The combination of claim 9 wherein said quick-attach implement mounting apparatus at the forward end of said boom arm extension apparatus comprises first and second horizontally spaced-apart quick-attach members.

11. A boom extension apparatus for mounting on the forward ends of a pair of boom arms of a skid-steer loader which have quick-attach mechanisms thereon, comprising:
an elongated frame means having rearward and forward ends;
a female quick-attach assembly mounted on the rearward ends of said extender frame means for quick-attachment to the quick-attachment mechanisms on the forward ends of the boom arms;
and a male quick-attach assembly mounted on the forward end of said extender frame means for quick-attachment to the rearward end of an implement.

12. The apparatus of claim 11 wherein said male quick-attach assembly at the forward end of said extender frame means is pivotally mounted thereto about a horizontal axis transverse to said boom arms.
